(19) United States
(12) Patent Application Publication
(10) Pub. No.: US 2007/0133747 A1
(43) Pub. Date: Jun. 14, 2007

(54) System and method for imaging using distributed X-ray sources

(75) Inventors: Joseph John Manak, Albany, NY (US); Douglas Albagli, Clifton Park, NY (US); Richard Allen Thompson, Clifton Park, NY (US); Michael John Harsh, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/297,711

(22) Filed: Dec. 8, 2005

(51) Int. Cl. G01N 23/04

(52) U.S. Cl. 378/62

(57) ABSTRACT

A technique is provided for efficient dose management and/or scatter reduction during imaging. The technique includes estimating attenuation level of different portions of an imaged object, and independently adjusting at least one of X-ray flux and X-ray energy spectrum from each of a plurality of emission points of a distributed X-ray source based on the attenuation level of different portions of the imaged object. The technique also includes acquiring two or more projection images of different portions of an entire field of view via the distributed X-ray source, removing respective scatter components from each of the two or more projection images, and combining the projection images less scatter components to generate a final projection image of the entire field of view.

### BACKGROUND

The invention relates generally to the field of non-invasive imaging, including medical imaging. In particular, the present invention relates to techniques for dose management and/or scatter reduction using a distributed source.

Imaging systems are utilized for various applications in both medical and non-medical fields. For example, medical imaging systems include general radiological, mammography, X-ray C-arm, tomosynthesis, and computed tomography (CT) imaging systems. These various imaging systems, with their different respective topologies, are used to create images or views of a patient based on the attenuation of radiation (e.g., X-rays) passing through the patient. Based on the attenuation of the radiation, the topology of the imaging system, and the type and amount of data collected, different views may be constructed, including views showing motion, contrast enhancement, volume reconstructions, two-dimensional images and so forth. Alternatively, imaging systems may also be utilized in non-medical applications, such as in industrial quality control or in security screening of passenger luggage, packages, and/or cargo. In such applications, acquired data and/or generated images representing volumes or parts of volumes (e.g., slices) may be used to detect objects, shapes or irregularities which are otherwise hidden from visual inspection and which are of interest to the screener.

Typically, X-ray imaging systems, both medical and non-medical, utilize an X-ray tube to generate the X-rays used in the imaging process. In particular, conventional single, rotating-anode X-ray tubes, which have single emission point that illuminates the entire field of view simultaneously, are typically employed as a source of X-rays in X-ray based imaging systems. Thus, the spatial distribution of X-rays is fixed and must be optimized for different patient anatomies and imaging processes. As a result, parts of the patient may be exposed to excess radiation in order to obtain good image quality in other parts. Current techniques to reduce patient dose while improving image quality include use of conventional and dynamic collimation as well as monochromatic sources. However, it is difficult to dynamically vary the spatial distribution of X-ray flux and/or energy spectrum in such X-ray tubes.

Additionally, signals corresponding to unattenuated X-rays along a particular projection path are confounded with signals resulting from scattering due to the presence of scattering material throughout the entire field of view. This result in degradation of image quality as the X-rays are scattered in the patient before reaching the detector. Current techniques to reduce scattering involves use of anti-scatter grids and slot scan type designs where a single x-ray source is collimated down to a narrow slot which is scanned across the field of view. However, these techniques suffer from the problem of blocking some of the primary radiation in addition to scattered radiation.

It is therefore desirable to provide improved imaging systems and techniques incorporating X-ray sources that enable better dose management and/or scatter reduction without compromising the image quality.

### BRIEF DESCRIPTION

Briefly in accordance with one aspect of the present technique, a method is provided for imaging. The method provides for estimating attenuation level of different portions of an imaged object, and independently adjusting at least one of X-ray flux and X-ray energy spectrum from each of a plurality of emission points of a distributed X-ray source based on the attenuation level of different portions of the imaged object. The method also provides for acquiring two or more projection images of different portions of an entire field of view via the distributed X-ray source, removing respective scatter components from each of the two or more projection images, and combining the projection images less scatter components to generate a final projection image of the entire field of view. Systems and computer programs that afford functionality of the type defined by this method may be provided by the present technique.

In accordance with another aspect of the present technique, a method is provided for imaging. The method provides for estimating attenuation level of different portions of an imaged object, and independently adjusting spatial distribution of at least one of X-ray flux and X-ray energy spectrum from each of a plurality of emission points of a distributed X-ray source based on the attenuation level of different portions of the imaged object. Systems and computer programs that afford functionality of the type defined by this method may be provided by the present technique.

In accordance with a further aspect of the present technique, a method is provided for imaging. The method provides for acquiring two or more projection images of different portions of an entire field of view via a distributed X-ray source, removing respective scatter components from each of the two or more projection images, and combining the projection images less scatter components to generate a final projection image of the entire field of view. Systems and computer programs that afford functionality of the type defined by this method may be provided by the present technique.

### DRAWINGS

These and other features, aspects, and advantages of the present invention will become better understood when the following detailed description is read with reference to the accompanying drawings in which like characters represent like parts throughout the drawings, wherein:

FIG. 1 depicts an exemplary imaging system using one or more distributed sources in accordance with one aspect of the present technique;

FIG. 2 depicts an exemplary distributed source for use in the imaging system of FIG. 1;

FIG. 3 depicts an alternative embodiment of the distributed source of FIG. 2 in which steered electron beam is employed;

FIG. 4 depicts a portion of a detector for use in the imaging system of FIG. 1;

FIG. 5 is a flowchart illustrating a process for dose management via a distributed source in accordance with aspects of the present technique;

FIG. 6 is a schematic diagram illustrating the process for dose management of FIG. 5;

FIG. 7 is an example of imaging chest by applying different levels of X-rays dose to different portions of the chest in accordance with the process of FIG. 5;

FIG. 8 is a flowchart illustrating a process for scatter reduction via a distributed source in accordance with aspects of the present technique;

FIG. 9 is a schematic diagram illustrating the process for scatter reduction of FIG. 8;

FIG. 10 is an example of imaging chest by acquiring two projection images of different portions of the chest in accordance with the process of FIG. 8; and

FIG. 11 is an example of imaging chest by combining the techniques for dose management and scatter reduction.

### DETAILED DESCRIPTION

The present techniques are generally directed to imaging with effective dose management and/or scatter reduction using distributed sources. Such imaging techniques may be useful in a variety of medical imaging contexts, such as general radiography, mammography, CT imaging, tomosynthesis, C-arm systems and others. Though the present discussion provides examples in a medical imaging context, one of ordinary skill in the art will readily comprehend that the application of these techniques in other contexts, such as for industrial imaging, security screening, and/or baggage or package inspection, is well within the scope of the present techniques.

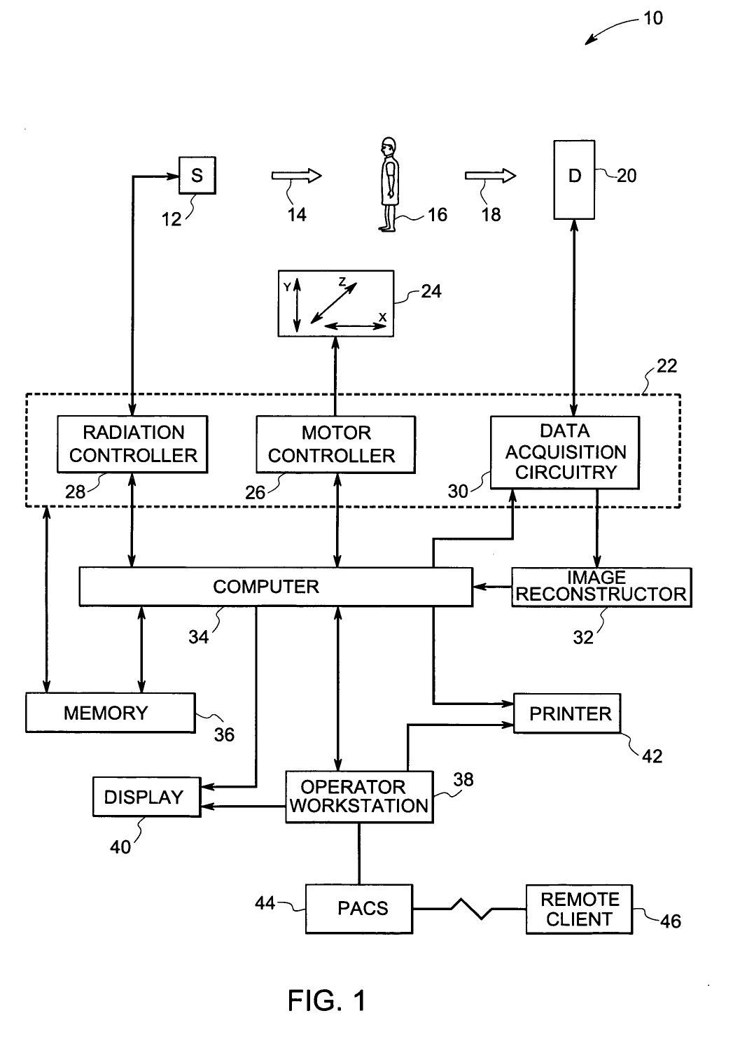

Referring now to FIG. 1, an imaging system 10 for use in accordance with the present technique is illustrated. In the illustrated embodiment, the imaging system 10 includes a radiation source 12, such as an X-ray source. In the embodiments discussed herein, the X-ray source is a distributed X-ray source consisting of two or more discrete, i.e., separated, emission points. A collimator (not shown) may be positioned adjacent to the radiation source 12. The collimator may consist of a collimating region, such as lead or tungsten shutters, for each emission point of the source 12. The collimator typically defines the size and shape of the one or more streams of radiation 14 that pass into a region in which a subject, such as a human patient 16, is positioned. The radiation 14 passes through the subject, which provides the attenuation, and resulting attenuated portion of the radiation 18 impacts a detector array, represented generally by reference numeral 20. It should be noted that portions of the X-ray beam 14 may extend beyond the boundary of the patient 16 and may impact detector 20 without being attenuated by the patient 16.

The detector 20 is generally formed by a plurality of detector elements, which detect the X-rays 18 that pass through or around the subject. For example, the detector 20 may include multiple rows and/or columns of detector elements arranged as an array. Each detector element, when impacted by an X-ray flux, produces an electrical signal when exposed to one or more individual X-ray photons at the position of the individual detector element in detector 20. Typically, signals are acquired at one or more view angle positions around the subject of interest so that a plurality of radiographic views may be collected. These signals are acquired and processed to reconstruct an image of the features within the subject, as described below.

The radiation source 12 is controlled by a system controller 22, which furnishes power, focal spot location, control signals and so forth for imaging sequences. Moreover, the detector 20 is coupled to the system controller 22, which controls the acquisition of the signals generated in the detector 20. The system controller 22 may also execute various signal processing and filtration functions, such as for initial adjustment of dynamic ranges, interleaving of digital image data, and so forth. In general, system controller 22 commands operation of the imaging system 10 to execute examination protocols and to process acquired data. In the present context, system controller 22 may also include signal processing circuitry, typically based upon a general purpose or application-specific digital computer, and associated memory circuitry. The associated memory circuitry may store programs and routines executed by the computer, configuration parameters, image data, and so forth. For example, the associated memory circuitry may store programs or routines for implementing the present technique.

In the embodiment illustrated in FIG. 1, system controller 22 may control the movement of a motion subsystem 24 via a motor controller 26. In the depicted imaging system 10, the motion subsystem 24 may move the X-ray source 12, the collimator 14, and/or the detector 20 in one or more directions in space with respect to the patient 16. It should be noted that the motion subsystem 24 might include a support structure, such as a C-arm or other movable arm, on which the source 12 and/or the detector 20 may be disposed. The motion subsystem 24 may further enable the patient 16, or more specifically a patient table, to be displaced with respect to the source 12 and the detector 20 to generate images of particular areas of the patient 16.

As will be appreciated by those skilled in the art, the source 12 of radiation may be controlled by a radiation controller 28 disposed within the system controller 22. The radiation controller 28 may be configured to provide power and timing signals to the radiation source 12. In addition, the radiation controller 28 may be configured to provide focal spot location, for example, emission point activation, if the source 12 is a distributed source comprising discrete electron emitters. As described below, suitable electron emitters include one or more conventional thermionic based cathodes or a cold cathode based electron source.

Further, the system controller 22 may comprise a data acquisition circuitry 30. In this exemplary embodiment, the detector 20 is coupled to the system controller 22, and more particularly to the data acquisition circuitry 30. The data acquisition circuitry 30 receives data collected by readout electronics of the detector 20. In particular, the data acquisition circuitry 30 typically receives sampled analog signals from the detector 20 and converts the data to digital signals for subsequent processing by an image reconstructor 32 and/or a computer 34.

The computer or processor 34 is typically coupled to the system controller 22. The data collected by the data acquisition circuitry 30 may be transmitted to the image reconstructor 32 and/or the computer 34 for subsequent processing and reconstruction. For example, the data collected from the detector 20 may undergo pre-processing and calibration at the data acquisition circuitry 30, the image reconstructor 32, and/or the computer 34 to condition the data to represent the line integrals of the attenuation coefficients of the scanned objects. The processed data may then be reordered, filtered, and backprojected to formulate an image of the scanned area. Although a typical filtered back-projection reconstruction algorithm is described in the present aspect, it should be noted that any suitable reconstruction algorithm may be employed, including statistical reconstruction approaches. Once reconstructed, the image produced by the imaging system 10 reveals an internal region of interest of the patient 16 which may be used for diagnosis, evaluation, and so forth.

The computer 34 may comprise or communicate with a memory 36 that can store data processed by the computer 34 or data to be processed by the computer 34. It should be understood that any type of computer accessible memory device capable of storing the desired amount of data and/or code may be utilized by such an exemplary system 10. Moreover, the memory 36 may comprise one or more memory devices, such as magnetic or optical devices, of similar or different types, which may be local and/or remote to the system 10. The memory 36 may store data, processing parameters, and/or computer programs comprising one or more routines for performing the processes described herein. Furthermore, memory 36 may be coupled directly to system controller 22 to facilitate the storage of acquired data.

The computer 34 may also be adapted to control features enabled by the system controller 22, i.e., scanning operations and data acquisition. Furthermore, the computer 34 may be configured to receive commands and scanning parameters from an operator via an operator workstation 38 which may be equipped with a keyboard and/or other input devices. An operator may thereby control the system 10 via the operator workstation 38. Thus, the operator may observe the reconstructed image and other data relevant to the system from operator workstation 38, initiate imaging, and so forth.

A display 40 coupled to the operator workstation 38 may be utilized to observe the reconstructed image. Additionally, the scanned image may be printed by a printer 42 coupled to the operator workstation 38. The display 40 and the printer 42 may also be connected to the computer 34, either directly or via the operator workstation 38. Further, the operator workstation 38 may also be coupled to a picture archiving and communications system (PACS) 44. It should be noted that PACS 44 might be coupled to a remote system 46, such as a radiology department information system (RIS), hospital information system (HIS) or to an internal or external network, so that others at different locations may gain access to the image data.

One or more operator workstations 38 may be linked in the system for outputting system parameters, requesting examinations, viewing images, and so forth. In general, displays, printers, workstations, and similar devices supplied within the system may be local to the data acquisition components, or may be remote from these components, such as elsewhere within an institution or hospital, or in an entirely different location, linked to the image acquisition system via one or more configurable networks, such as the Internet, virtual private networks, and so forth.

The imaging system 10 described above may employ a variety of techniques to improve spatial and temporal resolution, to improve image quality, to improve longitudinal coverage, to reduce or effective manage dosage, and/or to reduce scatter. For example, as discussed herein, a distributed source 12 that employs multiple emission points may be employed. Activation of the emission points may be coordinated so that one or more emission points are active at a time, such as by employing an alternating activation scheme. In this manner, each emission point, when active, may provide some or all of the X-ray attenuation data required to form or reconstruct images of an object within a given field of view. In embodiments where only a subset of the projection data associated with the field of view are acquired at one time, the in-plane extent of the detector 20 may be reduced. The detector 20 may comprise elements with varying resolution, depending on the application and area of interest in the image volume. For example, for cardiac imaging, high-resolution detectors may be utilized in a region that the heart shadows, while detectors with reduced resolution may be used for the remaining portion of the imaging volume. Further, the spatial distribution of X-ray flux and/or X-ray energy spectrum at each of these emission points may be independently adjusted based on the application.

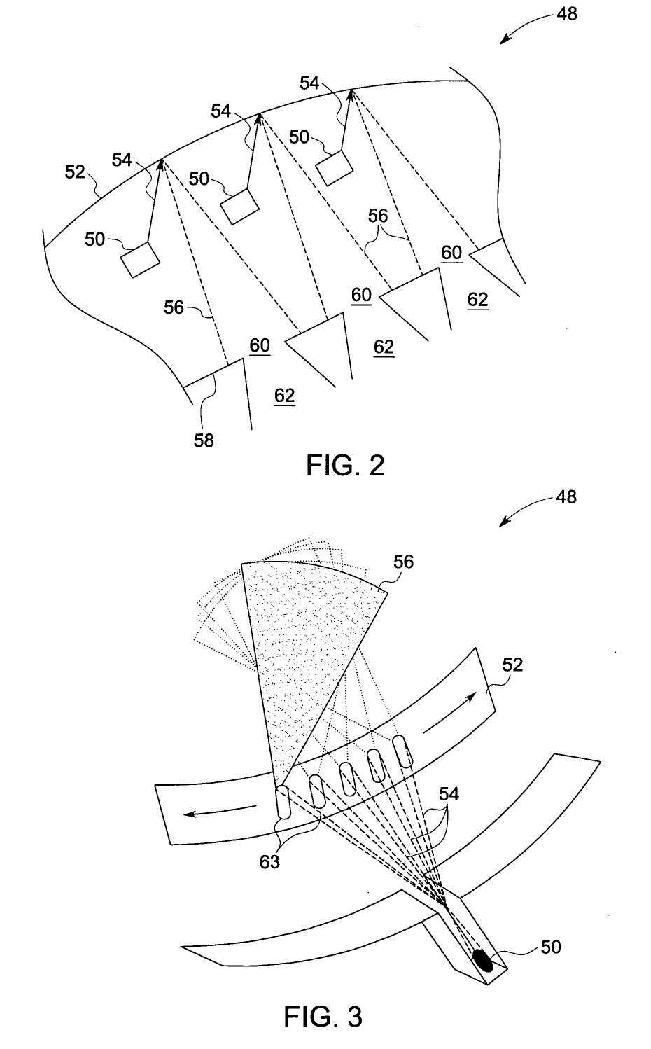

The imaging system 10 includes one or more moving or stationary distributed sources as well as one or more moving or stationary detectors for receiving radiation and processing corresponding signals to produce measurement data. FIG. 2 illustrates a portion of an exemplary distributed X-ray source 48 of the type that may be employed in the imaging system 10. As shown in FIG. 2, in an exemplary implementation, the distributed X-ray source 48 may include a series of addressable emission devices 50 housed in a vacuum housing that are coupled to radiation controller 28 shown in FIG. 1, and are triggered by the radiation controller 28 to emit electron beams during operation of the imaging system 10. The addressable emission devices 50 are positioned adjacent to a target 52 and, upon triggering by the radiation controller 28, may emit electron beams 54 toward target or anode 52. The target 52, which may, for example, be constructed of a high-density material rail, causes emission of beams of X-ray radiation, as indicated by reference numeral 56, resulting from the impinging electron beams 54. The high-density material may be, for example, tungsten or a tungsten alloy, molybdenum, tantalum or rhenium. Alternatively, high-density material may be coated at two or more places on a common rail so as to form a plurality of targets for the incoming electron beams. In reflection mode, X-rays are meant to be produced primarily on the same side of the target as where the electrons impact. In transmission mode, X-rays are produced at the opposite side of the target relative to the impinging beam of electrons. The X-ray beams 56 are directed, then, toward a collimator 58, which is generally opaque to the X-ray radiation, but which includes openings or apertures 60 that form multiple emission locations. The apertures 60 may be fixed in dimension, or may be adjustable. Apertures 60 permit a portion of the X-ray beams 56 to penetrate through the collimator to form collimated beams 62 that will be directed to the imaging volume, through the subject of interest, and that will impact detector elements.

A number of alternative configurations for emitters or distributed sources may, of course, be envisaged. Moreover, different X-ray generators in the distributed source may emit various types and shapes of X-ray beams. These may include, for example, fan-shaped beams, cone-shaped beams, and beams of various cross-sectional geometries. Similarly, the various components comprising the distributed X-ray source may also vary. In one embodiment, for example, a field emitter is envisaged as the addressable emission devices 50 which will be housed in a vacuum housing. Alternatively, the addressable emission devices 50 may be one of many available electron emission devices, for example, thermionic emitters, cold cathode emitters, carbon-based emitters, photo emitters, ferroelectric emitters, laser diodes, monolithic semiconductors, etc. A stationary anode is then disposed in the housing and spaced apart from the one or more electron emitters. This type of arrangement generally corresponds to the diagrammatical illustration of FIG. 2. Other materials, configurations, and principals of operations may also be employed for the distributed source.

For example, in one embodiment, a single addressable emission device 50 may be employed by the distributed source 48 to emit electron beams as illustrated in FIG. 3. In the illustrated embodiment, the addressable emission device 50 is configured to emit electron beam 54 that may be steered towards target or anode 52 such that the steered electron beam 54 impinges the target 52 at different emission points 63. The impinging electron beam 54 causes emission of beams of X-ray radiation, as indicated by reference numeral 56 from the respective emission points 63. It should be noted that, the addressable emission device 50 are coupled to and controlled by the radiation controller 28 shown in FIG. 1, as discussed above.

As discussed in greater detail below, the present techniques are based upon use of a plurality of distributed and addressable sources of X-ray radiation. Moreover, the distributed sources of radiation may be associated in single unitary enclosures or tubes or in a plurality of tubes designed to operate in cooperation. The individual emission points within the distributed X-ray source are addressable independently and separately so that radiation can be triggered from each of the emission points at different times during the imaging sequence as defined by the imaging protocol. Where desired, more than one such emission point may be triggered concurrently at any instant in time, or the emission points may be triggered in specific sequences to mimic two or three-dimensional motion, such as circular or helical rotation or linear or arcuate translations, or in any desired sequence around the imaging volume or plane. Similarly, in the embodiment where a single addressable emission device is employed, the electron beam may be steered in specific sequence to mimic two or three-dimensional motion. Further, the spatial distribution of X-ray flux and/or X-ray energy spectrum from the different X-ray generators may be adjusted depending upon the application and requirement.

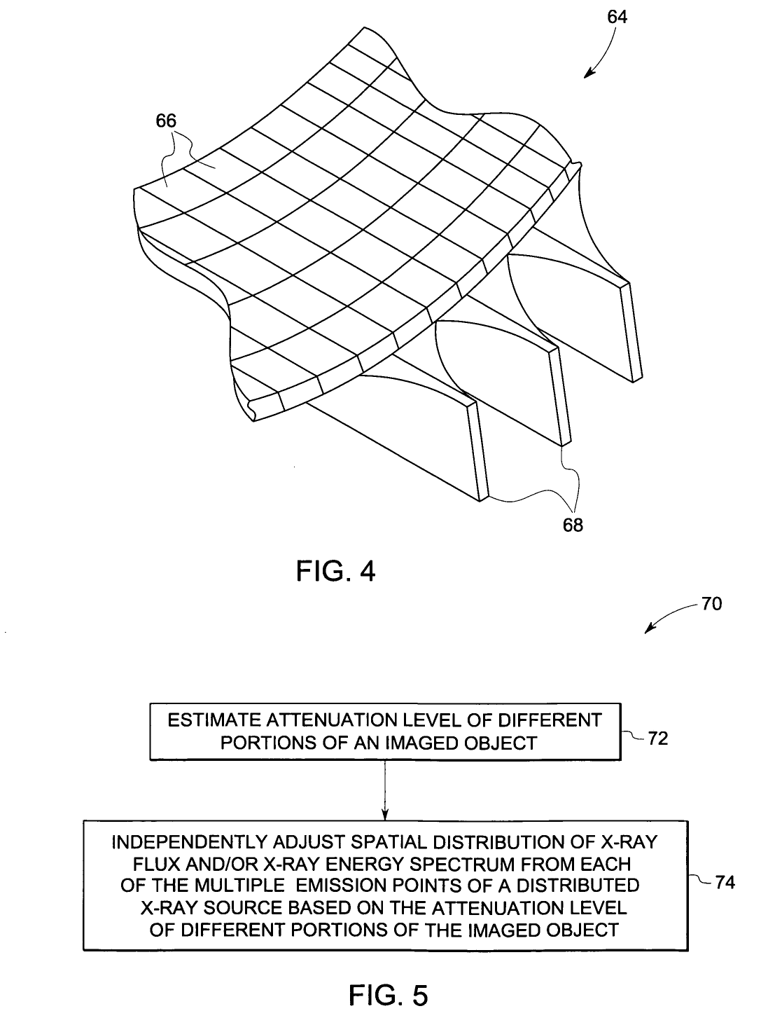

As noted above, a plurality of detector elements form one or more detectors, which receive the radiation emitted by the distributed source or sources. FIG. 4 illustrates a portion of such a detector that may be employed for the present purposes. Each detector may be comprised of detector elements with varying resolution to satisfy a particular imaging application. In general, the detector 64 includes a series of detector elements 66 and associated signal processing units 68. These detector elements may be of one, two or more sizes, resulting in different spatial resolution characteristics for different portions of the field of view. Each detector element 66 may include an array of photodiodes and associated thin film transistors. For example, in one embodiment, X-ray radiation impacting the detectors is converted to lower energy photons by a scintillator and these photons impact the photodiodes. A charge maintained across the photodiodes is thus depleted, and the transistors may be controlled to recharge the photodiodes and thus measure the depletion of the charge. By sequentially measuring the charge depletion in the various photodiodes, each of which corresponds to a pixel in the collected data for each acquisition, data is collected that indirectly encodes radiation attenuation at each of the detector pixel locations. This data is processed by the signal processing unit 68, which will generally convert the analog depletion signals to digital values, perform any necessary processing, and transmit the acquired data to processing circuitry of the imaging system as described above.

A large number of detector elements 66 may be present in the detector so as to define many rows and columns of pixels. As described below, the detector configurations of the present technique position detector elements across from independently addressable distributed X-ray sources so as to permit data collection from one or more view angle positions for image generation or reconstruction. Although the detector is described in terms of a scintillator-based energy-integrating device, direct-conversion, photon-counting, or energy-discriminating detectors are equally suitable.

As will be appreciated by one skilled in the art, a variety of activation schemes may be practiced for the distributed sources in accordance aspects of the present technique for better dose management and/or scatter reduction without compromising the image quality. For example, the exemplary imaging system 10 may acquire image data by the techniques discussed herein, so as to effectively manage X-ray exposure to the patient and/or reduce scattering. In particular, as will be appreciated by those of ordinary skill in the art, control logic and/or automated routines for performing the techniques and steps described herein may be implemented by the imaging system 10, either by hardware, software, or combinations of hardware and software. For example, suitable code may be accessed and executed by the computer 34 to perform some or all of the techniques described herein. Similarly application specific integrated circuits (ASICs) configured to perform some or all of the techniques described herein may be included in the computer 34 and/or the system controller 22.

For example, referring now to FIG. 5, exemplary control logic 70 for managing X-ray dose while acquiring images via a system such as imaging system 10 is depicted via a flowchart in accordance with aspects of the present technique. As illustrated in the flowchart, exemplary control logic 70 includes the step of estimating attenuation level of different portions of the imaged object at step 72. The control logic 70 further includes the step of independently adjusting spatial distribution of X-ray flux and/or X-ray energy spectrum from each of the multiple emission points of the distributed X-ray source based on the attenuation level of the different portions of the imaged object at step 74.

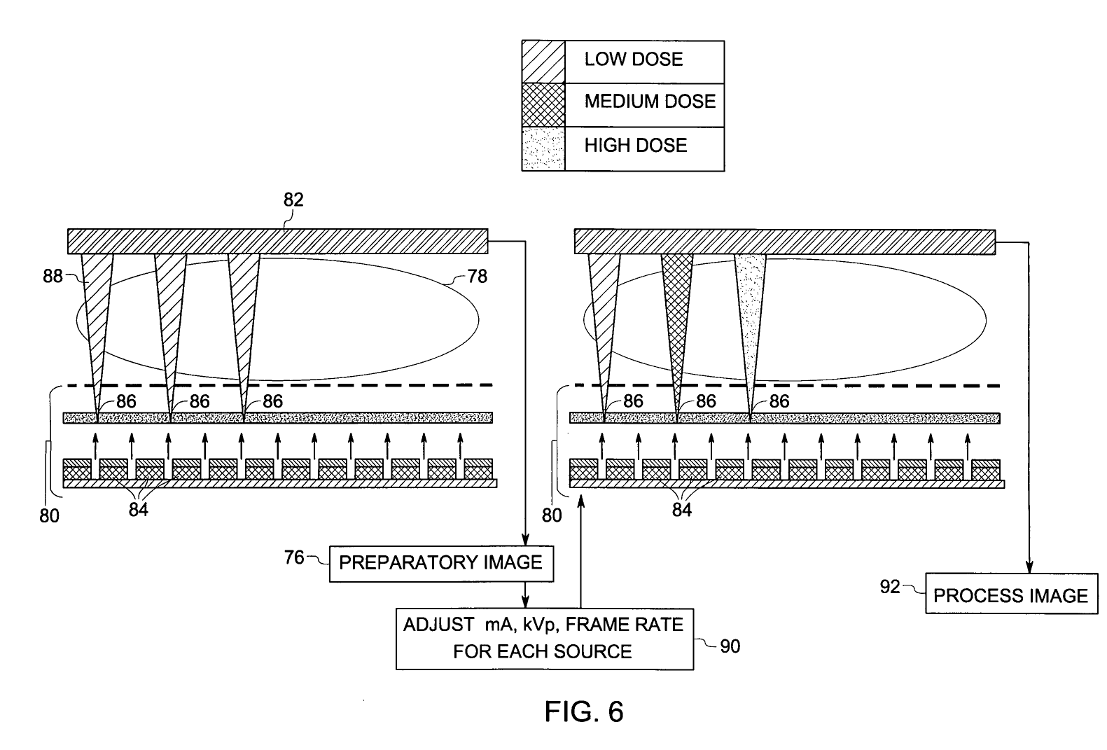

As will be appreciated by one skilled in the art, the attenuation level of different portions of the imaged object may be estimated from a previously acquired image or set of images of the object of interest. Alternatively, a preliminary or preparatory projection image of the object may be acquired prior to actual imaging for estimating the attenuation level of different portions of the object. A schematic diagram illustrating the process of dose management by acquiring a preparatory image is depicted in FIG. 6. As illustrated, a preparatory image 76 of the object 78 may be acquired via a distributed X-ray source 80 and a detector 82 by activating multiple emitters 84, corresponding to respective emission points 86, to emit X-rays 88 of lower intensity and lower flux than that required for normal imaging, such that the object is exposed to low X-ray dose. The attenuation level of different portions of the imaged object 78 may then be estimated from the preliminary projection image 76. Based on the attenuation level of different portions of the imaged object 78, the spatial distribution of X-ray flux and/or X-ray energy spectrum from each of the multiple emission points may be independently adjusted via a radiation controller. For example, portions of the object with high attenuation level (e.g., bones, ribs and so forth) need higher X-ray dose for good image quality while other portions with low attenuation level (e.g., tissues, organs and so forth) need not be exposed to such high X-ray dose and may be imaged with a medium or lower level of X-ray dose.

The X-ray flux may be adjusted by dynamically varying emitter current (mA) in each of the multiple emitters corresponding to the respective emission points. As will be appreciated by one skilled in the art, the number of photons emitted from the emitters increases as the emitter current (mA) increases, thereby increasing the X-ray flux at the respective emission point. In other words, the X-ray flux may be adjusted by dynamically varying individual electron source integrated current of each of a plurality of emission points. Additionally, the X-ray energy spectrum may be adjusted by dynamically varying potential difference (kVp) between each of the multiple emitters corresponding to the respective emission points and respective target. As one of ordinary skill in the art will appreciate, the mean energy (intensity) of the X-ray beam increases as the potential difference (kVp) between the emitter and the target increases. Thus at high potential difference hard X-rays are emitted while at lower potential difference soft X-rays are emitted. Additionally, the frame rate of exposures may be adjusted based on motion of different portions of the imaged object. For example, portions of the object showing rapid motion may require higher frame rate while the portions of the object that is stationary or moving very slowly may require lower frame rate. Thus, in fluoroscopic applications one can restrict dose to only areas of patient motion and/or allow differing effective frame rates for different areas of motion, thereby allowing for high dose in areas of high motion and low dose in areas with little motion.

Once the various activation parameters are adjusted at block 90 for each of the multiple emitters based on the attenuation level of different portions of the imaged object 78, the image acquisition may be performed and one or more projection images of the object may be acquired. The image may then be processed at block 92 for visualization, analysis, and/or diagnosis. In one embodiment, a reconstruction may be performed on the acquired projection images for subsequent visualization, analysis or diagnosis. It should be noted that a gain and incident flux correction is applied to the acquired projection images to take into account the spectral and/or flux adjustment across the field of view. In this way, the image can be made approximately proportional to the true amount of mass attenuation present along each line integral. In certain embodiments, the correction may be performed by multiplying intensity of pixels corresponding to the different portions of the imaged object with a factor in which the X-ray flux and/or the X-ray energy spectrum was adjusted for the respective portions of the imaged object. Additional processing may also be performed to make the image suitable for display. Further, to account for variable frame rate, the image may be processed by updating only the areas of the field of view that have been exposed to additional dose.

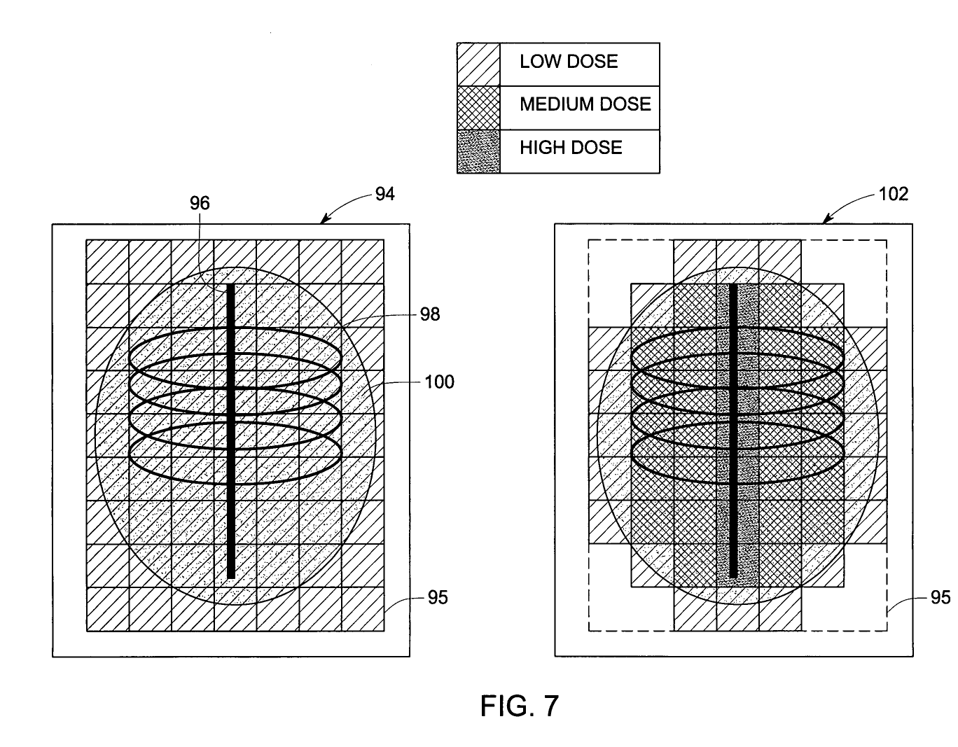

An example of chest imaging by applying different levels of X-rays dose to different portions of the chest in accordance with the techniques described above is illustrated in FIG. 7. As illustrated, a preparatory image of chest 94 may be acquired by applying a low dose X-ray exposure than the normal over the entire field of view 95. Based on the attenuation level of different portions of the chest, an optimum level of X-ray dose for the different portions is estimated. In the illustrated example, the spinal cord 96 and the ribs 98 have the maximum attenuation while the lungs 100 have lower attenuation. Thus, the spatial distribution of X-ray flux and/or X-ray energy spectrum from each of the multiple emission points in the distributed X-ray source may be adjusted such that, the portions of the chest having higher level of attenuation are exposed to higher X-ray flux and intensity while the portions having low attenuation are exposed to medium or lower X-ray flux and intensity. The portions of the imaged object that are within the field of view 95 but are not of interest may be exposed to negligible level of X-ray flux and/or intensity or may not be exposed to X-rays at all. A final image of the chest 102 may then be acquired with the adjusted level of X-ray exposure for different portions of the chest.

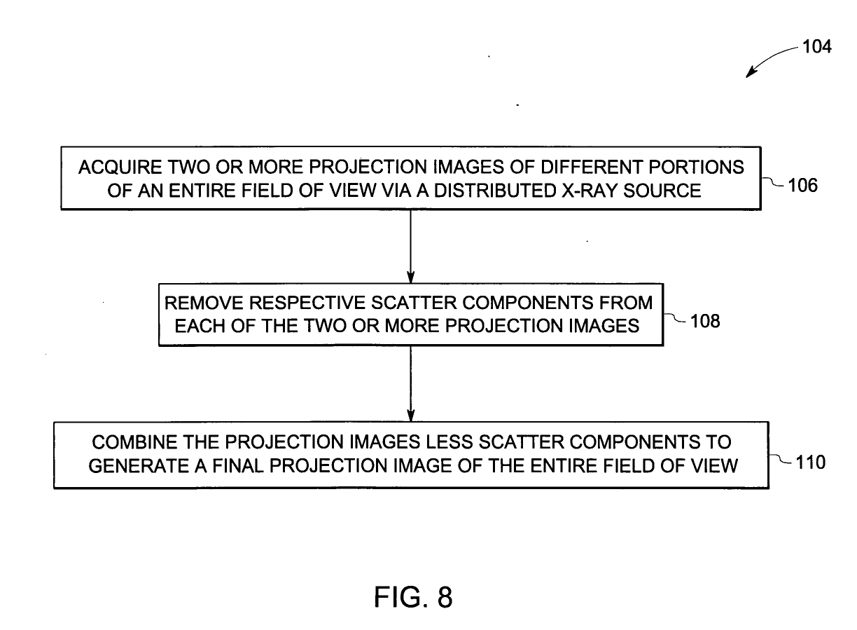

By further example, exemplary control logic 104 for reducing scatter while acquiring images via a system such as imaging system 10 is depicted via a flowchart in FIG. 8 in accordance with aspects of the present technique. As illustrated in the flowchart, exemplary control logic 104 includes the step of acquiring two or more projection images of different portions of an entire field of view via the distributed X-ray source at step 106 and removing respective scatter components from each of the two or more projection images at step 108. The control logic 104 further includes combining the projection images less scatter components to generate a final projection image of the entire field of view at step 110.

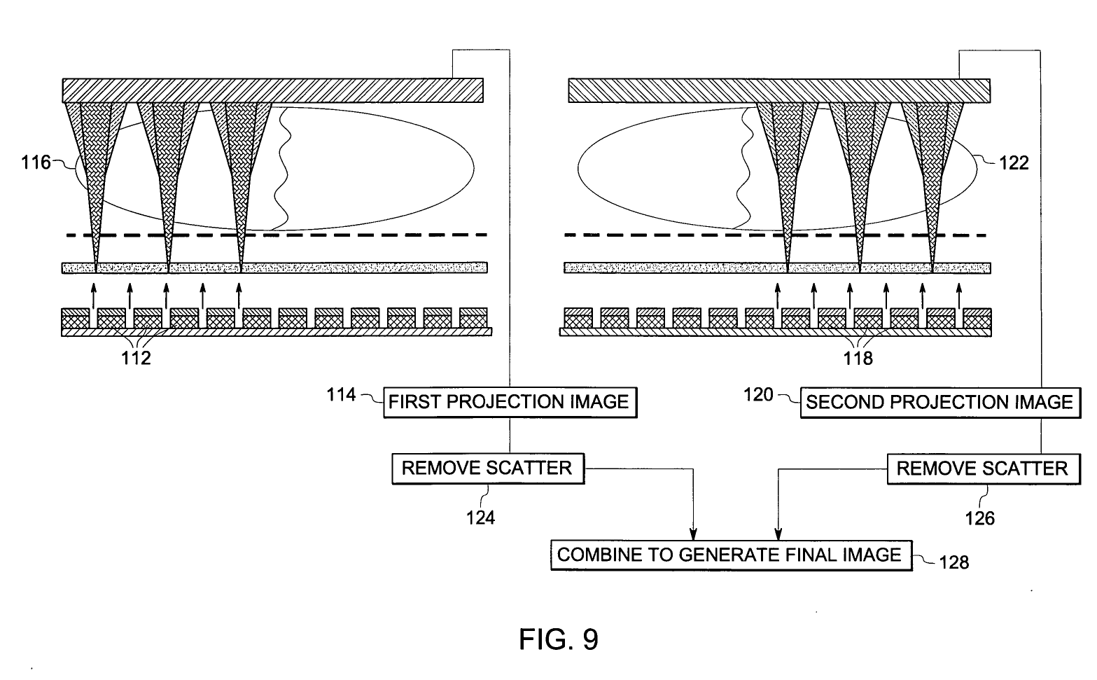

As will be appreciated by one skilled in the art, two or more projection images of different portions of the entire field of view may be acquired by triggering different fractions of the multiple emission points of the distributed X-ray source for each image acquisition. Further, it should be noted that, the detector read out may be synchronized with the acquisition pattern of the source. A schematic diagram illustrating the process of scatter reduction by technique described above is depicted in FIG. 9. As illustrated, in one embodiment, a first fraction 112 of the multiple emitters corresponding to respective emission points is triggered to acquire a first projection image 114 of a first portion 116 of the entire field of view. In subsequent acquisition, a second fraction 118 of the multiple emitters corresponding to respective emission points may be triggered to acquire a second projection image 120 of a second portion 122 of the entire field of view. It should be noted that, in certain embodiments, different fractions of the multiple emission points as well as different potions of the entire field of view may be complementary to each other so that the entire field of view may be captured. For example, in the illustrated example, the first 112 and the second 118 fractions of the multiple emission points as well as the first 116 and the second 122 portions of the entire field of view is complementary to each other such that the complete field of view is captured. The scatter may then be removed from each of the projection images at block 124 and 126 respectively. Alternatively, only the primary fraction of the field of view may be retained or acquired in each of the projection images. The scatter free images may then be combined at block 128 to generate the projection image of the entire field of view. The image may then be processed for display, analysis and/or diagnosis.

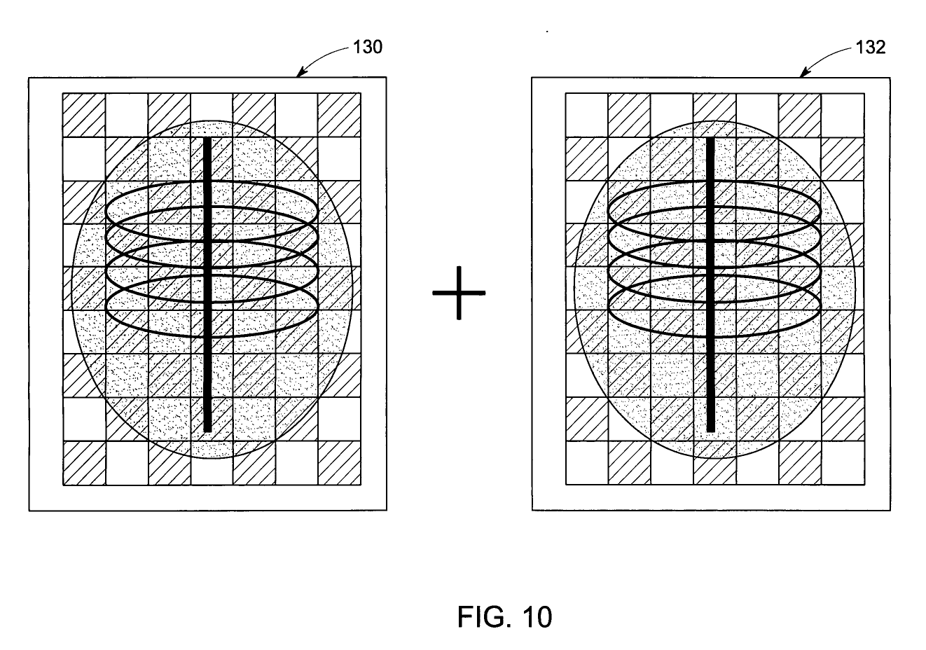

An example of chest imaging by applying scatter reduction techniques described above is illustrated in FIG. 10. As illustrated in the example, two projection images 130 and 132 of different portions of the chest are acquired by triggering different fractions of the multiple emission points. The scatter from each of these two images is then removed. The two images are then combined to generate the complete image of the chest that is relatively free of scatter.

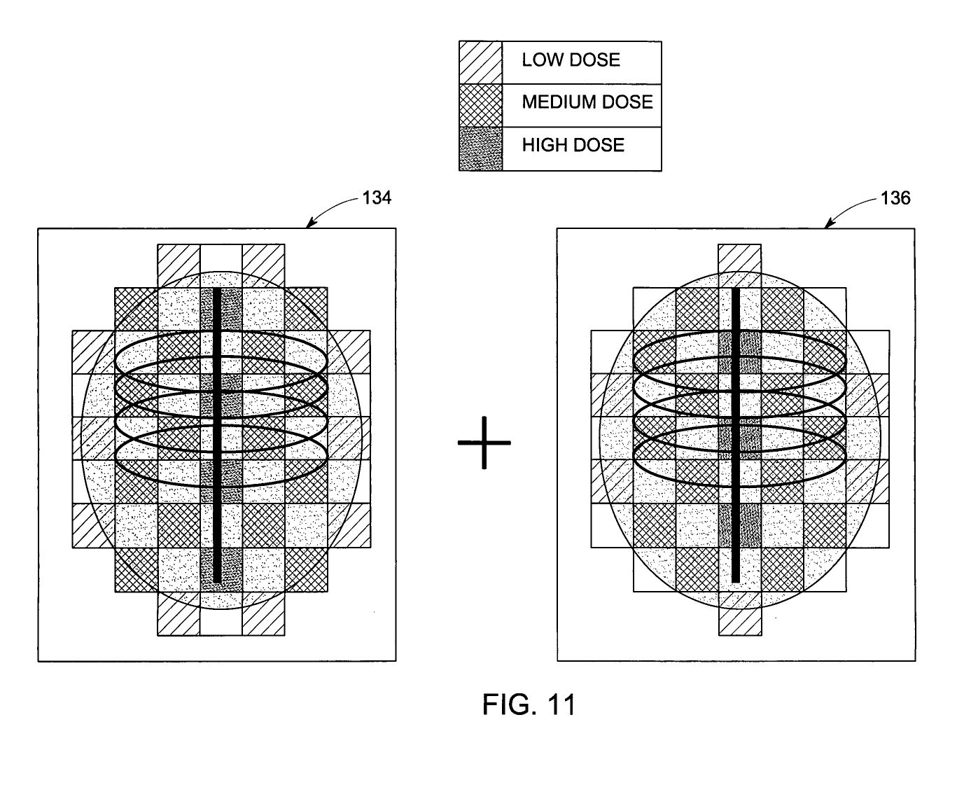

As will be appreciated by one skilled in the art, in certain embodiments, the techniques for dose management and the techniques for scatter reduction may be combined during the image acquisition. The combined technique may include the steps of estimating attenuation level of different portions of an imaged object, independently adjusting spatial distribution of X-ray flux and/or X-ray energy spectrum from each of the multiple emission points of the distributed X-ray source based on the attenuation level of different portions of the imaged object, acquiring two or more projection images of different portions of an entire field of view via the distributed X-ray source, removing respective scatter components from each of the two or more projection images, and combining the projection images less scatter components to generate a final projection image of the entire field of view. An example of chest imaging by combining the techniques for dose management and scatter reduction described above is illustrated in FIG. 11. In the illustrated example, an optimum level of X-ray dose for the different portions is estimated based on the attenuation level of different portions of the chest as described above. The spatial distribution of X-ray flux and/or X-ray energy spectrum from each of the multiple emission points in the distributed X-ray source may then be adjusted accordingly. Further, two projection images 134 and 136 of different portions of the chest are acquired by triggering different fractions of the multiple emission points. The acquired projection images 134 and 136 may then be processed for removing scatter from each of the images. The images are finally combined to generate the complete image of the chest that is relatively free of scatter. As noted above, a correction may be applied to the final image to take into account the spectral and/or flux adjustment across the field of view. This may be performed by multiplying intensity of pixels corresponding to the different portions of the imaged object with a factor in which the X-ray flux and/or the X-ray energy spectrum was adjusted for the respective portions of the imaged object.

As will be appreciated by one skilled in the art, the techniques described in the various embodiments discussed above, provides the benefit of dose reduction, image optimization, scatter reduction, noise equalization, and/or dynamic range compression during an imaging procedure. The ability to vary the x-ray energy spectrum and X-ray flux from each source independently is used to provide control over the x-ray flux and X-ray energy spectrum applied along various attenuation paths through the patient, thereby efficiently managing the dose delivered to the patient. As will be appreciated by one skilled in the art, by limiting exposure to parts of the patient that have low attenuation as described in above techniques, overall exposure of patient to X-rays may be reduced by significant amount (25-80%, for example). Further, by varying the incident X-ray spectrum across the field of view and/or by independently varying the frame rate of exposures the image quality may be optimized. Further, the techniques described above reduce the scatter in the acquired projection image that degrades image quality.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of imaging, comprising:
estimating attenuation level of different portions of an imaged object;
independently adjusting at least one of X-ray flux and X-ray energy spectrum from each of a plurality of emission points of a distributed X-ray source based on the attenuation level of different portions of the imaged object;
acquiring two or more projection images of different portions of an entire field of view via the distributed X-ray source;
removing respective scatter components from each of the two or more projection images; and
combining the projection images less scatter components to generate a final projection image of the entire field of view.

2. The method of claim 1, further comprising adjusting a frame rate of exposures based on motion of different portions of the imaged object.

3. The method of claim 1, wherein estimating the attenuation level comprises ascertaining the attenuation level from a previously acquired image or set of images of the object of interest.

4. The method of claim 1, wherein estimating the attenuation level comprises acquiring a preliminary projection image by exposing the imaged object to a lower X-ray dosage than normal and estimating the attenuation level of different portions of the imaged object from the preliminary projection image.

5. The method of claim 1, wherein independently adjusting the X-ray flux comprises dynamically varying individual electron source integrated current of each of a plurality of emission points.

6. The method of claim 1, wherein independently adjusting the X-ray energy spectrum comprises dynamically varying potential difference between each of a plurality of emitters corresponding to the respective emission points and respective target.

7. The method of claim 1, wherein acquiring two or more projection images of different portions of the entire field of view comprises triggering different fractions of the plurality of emission points for each image acquisition.

8. The method of claim 1, further comprising applying correction to the final projection image to take into account the X-ray flux adjustment across the field of view.

9. A method of imaging, comprising:
estimating attenuation level of different portions of an imaged object; and
independently adjusting spatial distribution of at least one of X-ray flux and X-ray energy spectrum from each of a plurality of emission points of a distributed X-ray source based on the attenuation level of different portions of the imaged object.

10. The method of claim 9, further comprising adjusting a frame rate of exposures based on motion of different portions of the imaged object.

11. The method of claim 9, wherein estimating the attenuation level comprises ascertaining the attenuation level from a previously acquired image or set of images of the object of interest.

12. The method of claim 9, wherein estimating the attenuation level comprises acquiring a preliminary projection image by exposing the imaged object to a lower X-ray dosage than normal and estimating the attenuation level of different portions of the imaged object from the preliminary projection image.

13. The method of claim 9, wherein independently adjusting the X-ray flux comprises dynamically varying individual electron source integrated current of each of a plurality of emission points.

14. The method of claim 9, wherein independently adjusting the X-ray energy spectrum comprises dynamically varying potential difference between each of a plurality of emitters corresponding to the respective emission points and respective target.

15. The method of claim 9, further comprising acquiring a plurality of projection images of the imaged object via the distributed X-ray source

16. The method of claim 15, further comprising applying correction to the plurality of projection images to take into account the X-ray flux and/or the X-ray energy spectrum adjustment across the field of view.

17. A method of imaging, comprising:
acquiring two or more projection images of different portions of an entire field of view via a distributed X-ray source;
removing respective scatter components from each of the two or more projection images; and
combining the projection images less scatter components to generate a final projection image of the entire field of view.

18. The method of claim 17, wherein acquiring two or more projection images of different portions of the entire field of view comprises triggering different fractions of a plurality of emission points of the distributed X-ray source for each image acquisition.

19. An imaging system, comprising:
a distributed X-ray source, wherein the distributed X-ray source is configured to emit X-rays from a plurality of emission points;
a processor configured to estimate attenuation level of different portions of an imaged object, and to independently adjust spatial distribution of at least one of X-ray flux and X-ray energy spectrum from each of the plurality of emission points based on the attenuation level of different portions of the imaged object; and
a detector configured to generate a plurality of signals in response to X-rays incident upon the detector.

20. The imaging system of claim 19, wherein the X-ray imaging system comprises a mammography system, a tomosynthesis system, a general radiographic X-ray system, an X-ray C-arm system, or a computed tomography system.

21. The imaging system of claim 19, wherein the distributed X-ray source comprises:
one or more addressable emission devices adapted to emit electron beams; and
one or more anodes spaced apart from the addressable emission devices for emitting X-rays at a plurality of emission points upon impingement of the electron beams.

22. The imaging system of claim 21, wherein the addressable emission devices comprises field emitters, thermionic emitters, cold-cathode emitters, carbon-based emitters, photo emitters, ferroelectric emitters, laser diodes, or monolithic semiconductors.

23. The imaging system of claim 21, wherein the addressable emission devices are configured to emit steered electron beams.

24. The imaging system of claim 19, wherein the processor is configured to adjust a frame rate of exposures based on motion of different portions of the imaged object.

25. The imaging system of claim 19, wherein the processor is configured to independently adjust the X-ray flux by dynamically varying individual electron source integrated current of each of a plurality of emission points.

26. The imaging system of claim 19, wherein the processor is configured to independently adjust the X-ray energy spectrum by dynamically varying potential difference between each of a plurality of emitters corresponding to the respective emission points and respective target.

27. An imaging system, comprising:
a processor configured to acquire two or more projection images of different portions of an entire field of view via a distributed X-ray source, to remove respective scatter components from each of the two or more projection images, and to combine the projection images less scatter components to generate a final projection image of the entire field of view.

28. The imaging system of claim 27, wherein the processor is configured to acquire two or more projection images of different portions of the entire field of view by triggering different fractions of a plurality of emission points of the distributed X-ray source for each image acquisition.
